(19) United States
(12) Patent Application Publication
(10) Pub. No.: US 2016/0081508 A1
(43) Pub. Date: Mar. 24, 2016

(54) Modularized Artificial Light Tree

(71) Applicant: Greenfields Christmas Tree Manufactory, Kowloon (HK)

(72) Inventor: Tony Yat Wah WONG, Kowloon (HK)

(21) Appl. No.: 14/701,253

(22) Filed: Apr. 30, 2015

(30) Foreign Application Priority Data
Sep. 18, 2014 (CN) 201420538665.3

(51) Int. Cl. A47G 33/06; H01R 27/02; F21V 21/104; F21V 27/00; F21S 4/00; F21V 23/06

(52) U.S. Cl. CPC A47G 33/06; F21S 4/001; F21V 23/06; F21V 21/104; F21V 27/00; H01R 27/02; F21W 2121/04

(57) ABSTRACT

The utility model belongs to the technical field of Christmas trees and particularly relates to a modularized artificial light tree. The present utility model aims to solve the technical problem about providing the artificial light tree which is convenient to use and maintain and on which the adjacent simulative boles are supplied with the power together. In order to solve the aforementioned problem, the present modularized artificial light tree at least comprises a first simulative bole and a second simulative bole, the top of the outer wall of the first simulative bole is fixedly connected with an electric socket I, and the bottom of the outer wall of the second simulative bole is provided with an electric plug II matched with the electric socket I and is fixedly connected with the electric plug II. The electric socket I and the electric plug II are supplied with the power together. The modularized artificial light tree has the advantages of convenience in use and maintenance and that the two adjacent simulative boles can be supplied with the power together and string lights can be conveniently replaced.

### TECHNICAL FIELD

The utility model belongs to the technical field of Christmas trees and particularly relates to a modularized artificial light tree.

### BACKGROUND

During the Christmas season, people are used to bringing the Christmas trees into their homes or shopping centers, decorating them with strings of lights and ornaments. However, to decorate a real pine causes quite a lot of trouble, so for convenience, people prefer an artificial pine, and manufacturers always tie strings of lights in the artificial pine boles as ornaments. Mostly, the artificial pine is disassembled into two to four boles so as to be packaged in boxes, each bole has many preinstalled decorative string lights, and electric connectors are usually exposed outside bole leaves. Customers have to assemble the boles and connect the adjacent electric connectors of the decorative lights of each bole so as to power on the lights in the whole tree. While partly due to the redundant string lights of each bole, the customers feel troublesome and take much time to match all the electric connectors of the string lights. Therefore, use is quite inconvenient. What's worse, if the electric connectors are arranged in the boles, it is almost unlikely to maintain the electronic part of the electronic connectors or electric wires in the lights of the boles. For instance, disconnection of only one light circuit or a connector in a metal bole may result in blackout of all the lights in the tree. It is very hard to maintain, or even the entire bole should be partially or integrally replaced.

### SUMMARY OF THE UTILITY MODEL

The present utility model aims to solve the technical problem about providing the artificial light tree which is convenient to use and maintain and on which the adjacent simulative boles are supplied with the power simultaneously.

In order to solve the aforementioned problem, the technical scheme includes that: the present modularized artificial light tree at least comprises a first simulative bole and a second simulative bole, the simulative boles are hollow tube stocks, and the top of the first simulative bole is detachably and fixedly connected with the bottom of the second simulative bole; the top of the outer wall of the first simulative bole is fixedly connected with the electric socket I, and the bottom of the outer wall of the second simulative bole is provided with the electric plug II matched with the electric socket I and is fixedly connected with the electric plug II. The light tree further comprises at least one string light. The tail end of each string light is provided with an electric plug III, the first simulative bole also comprises an electric socket II matched with the electric plug III, and the said electric socket II is fixed on the outer wall of the first simulative bole. The electric socket I and the electric plug II are supplied with the power together.

Preferably, the light tree further comprises holders, each holder consists of a holding hole and a positioning hole, the holding holes are matched with the electric sockets and the positioning holes are matched with the simulative boles.

Preferably, the top of the first simulative bole is provided with a groove or projection, and the bottom of the second simulative bole is provided with a projection I or groove I matched with the said groove or projection.

Preferably, at least one electric socket I and at least one electric plug II are provided.

Preferably, if more than two, the electric plugs are staggered.

Preferably, the cross section of the electric socket I and that of the first simulative bole are parallel to each other or arranged on the same plane.

Preferably, the light tree further comprises a third simulative bole, the top of the third simulative bole comprises an electric socket IV and at least one electric plug IV I, wherein the electric socket IV is connected with the other simulative bole, and the electric plugs IV I are connected with the string lights. The top of the second simulative bole is provided with an electric socket II I, and the bottom of the third simulative bole is provided with an electric plug IV II matched with the electric socket II I.

Preferably, the light tree further comprises a shell, and the shell wraps the electric socket I and the electric plug II inside and is provided with corresponding circuit holes.

Preferably, the shell is composed of a left half shell and a right half shell which are detachably and fixedly connected or an upper half shell and a lower half shell which are connected in the same way.

Preferably, each of the left half shell and the right half shell is composed of an upper part and a lower part.

The present utility model has the advantages that the said artificial light tree is convenient to use, the characteristics of the boles can be displayed as long as the simulative boles are sequentially connected, and the string lights can be connected after the electric plugs of the string lights are connected with the electric sockets on the boles; the said artificial light tree is also convenient to maintain as the electric sockets on the boles are independently and intensively set; the two adjacent simulative boles can be supplied with the power at the same time. Taking the first simulative bole as example, the electric socket I and the electric plug II are supplied with the power at the same time, when the electric plug II at the bottom of the outer wall of the second simulative bole is connected with the electric socket I at the top of the first simulative bole, the two adjacent simulative boles can be supplied with the power together; the artificial light tree is low in fault rate by the aid of the shell at the joints of the simulative boles, to be specifically, the shell can prevent the electric sockets from falling off easily, and the fault rate is resultantly lowered.

### BRIEF DESCRIPTION OF THE DRAWINGS

The present utility model will be more fully understood from the following description, given by several drawings showing the idea of the present utility model best. Beyond doubt, the accompanying drawings are provided for illustration only, not for stating the whole technical scheme of the utility model and even not for limiting the content of the utility model. It should be understood that any schemes designed under the revelation of the drawings belong to the scope of these claims.

FIG. 1 is a schematic view showing the integral light tree;

FIG. 2 is an overall schematic view showing the light tree from the other angle;

FIG. 3 is an enlarged view of a part A;

FIG. 4 is an enlarged view of a part B;

FIG. 5 is an enlarged view of a part C;

FIG. 6 is a schematic view showing a holder;

FIG. 7 is a structural schematic view showing the simulative bole of the Christmas tree comprising the shell;

FIG. 8 is a schematic and explosive view showing the simulative bole of the Christmas tree comprising the shell;

FIG. 9 is an explosive view showing the simulative bole of the Christmas tree comprising the shell.

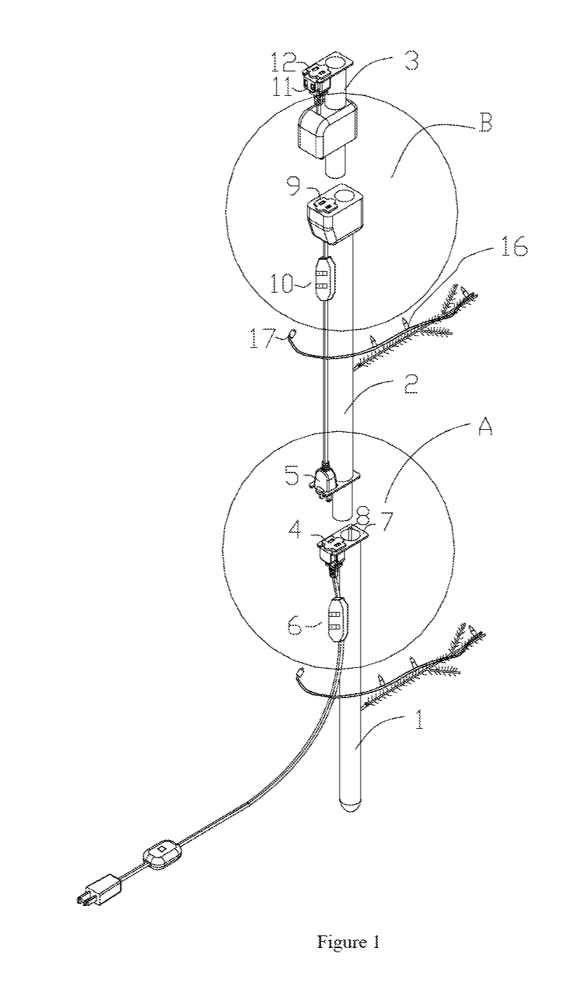

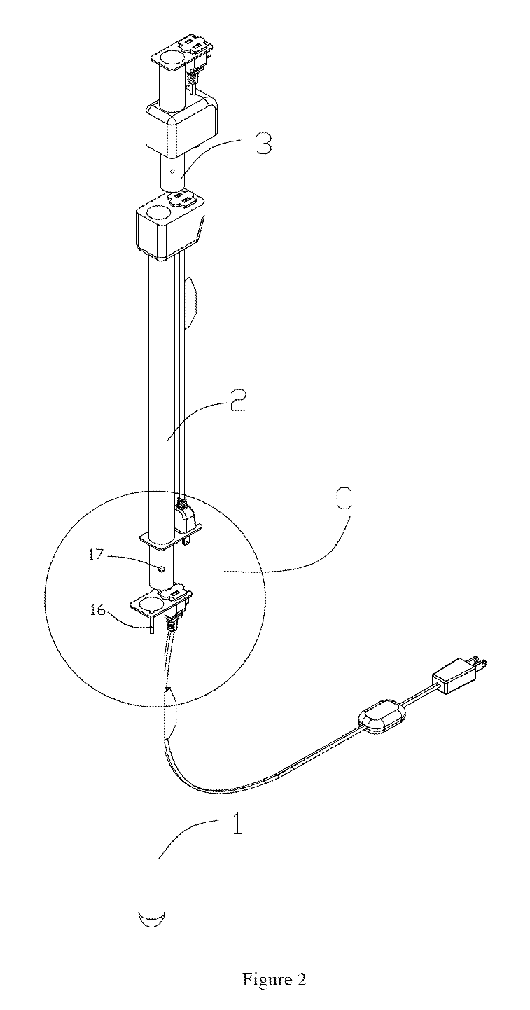

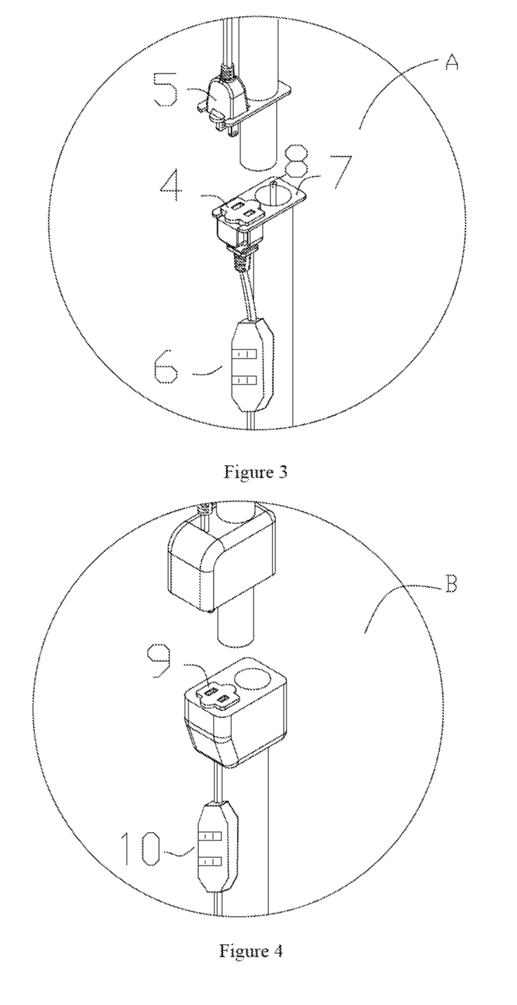

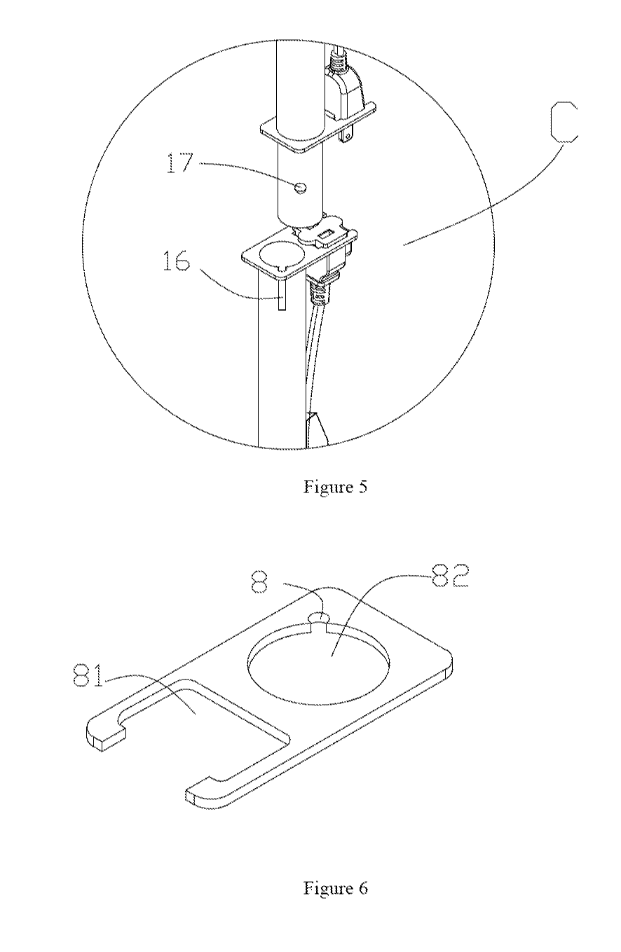

### DETAILED DESCRIPTION OF THE EMBODIMENTS

The present utility model will be more fully understood from the following description, given by several drawings showing the idea of the present utility model best. Beyond doubt, the accompanying drawings are provided for illustration only, not for stating the entire technical scheme of the utility model and even not for limiting the content of the utility model. It should be understood that any schemes designed under the revelation of the drawings belong to the scope of these claims. A modularized artificial light tree at least comprises a first simulative bole 1 and a second simulative bole 2, which are hollow tube stocks. The top of the first simulative bole is detachably and fixedly connected with the bottom of the second simulative bole; the top of the outer wall of the first simulative bole is fixedly connected with an electric socket I 4, the bottom of the outer wall of the second simulative bole is provided with an electric plug II 5 matched with the electric socket I 4 and is fixedly connected with the electric plug II 5. The light tree further comprises at least one string light 16, and the tail end of each string light is provided with an electric plug III17. The first simulative bole is provided with an electric connector I 16 matched with the electric plug III, and the electric connector I 16 is fixed on the outer wall of the first simulative bole. The electric socket 14 and the electric connector I 16 are supplied with the power together and can be integrated or be connected via leads.

For more conveniently fixing the electric sockets and connecting the two adjacent simulative boles, the light tree also comprises holders 7, each holder consists of a holding hole 81 and a positioning hole 82, the holding holes are matched with the electric sockets and the positioning holes are matched with the simulative boles. For conveniently connecting the two adjacent simulative boles, especially the electric sockets, the first simulative bole is provided with the groove or projection at the top, and the second simulative bole is provided with the projection I or groove I matched with the groove or projection at the bottom. That is, when the first simulative bole is provided with the groove 16 at the top, the second simulative bole is correspondingly provided with the projection I 17 matched with the groove and vice versa. When the holders are mounted on the simulative boles and the simulative boles are provided with the grooves at the corresponding positions, the holders are also provided with small grooves 8 or projections correspondingly.

For conveniently connecting the string lights or the electric connectors, at least one electric socket I and at least one electric plug II are provided.

For better heat radiation and well arrangement of the string lights, the electric plugs II are staggered when provided more than two.

For joint connection of the two adjacent simulative boles, the cross section of the electric socket I and that of the first simulative bole are parallel to each other or arranged on the same plane.

Preferably, the light tree comprises a third simulative bole 3, the top of the third simulative bole is provided with an electric socket IV12 and at least one electric plug IV I11, the electric socket IV12 is connected with another simulative bole, and the electric plug IV I11 is connected with the string lights. The second simulative bole is further provided with an electric socket II I9 and at least one electric connector II II10 at the top so as to be conducive to connection of the string lights. The bottom of the third simulative bole is provided with an electric plug IV II matched with the electric socket II I9.

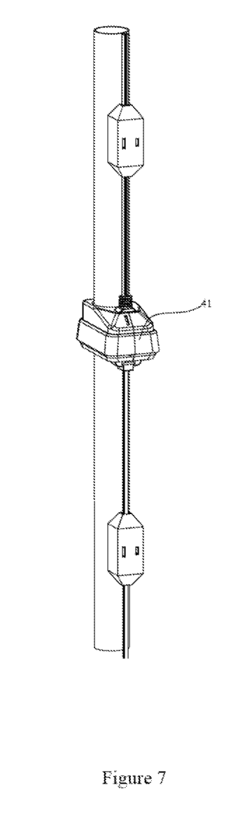

In order to prevent the electric sockets from falling off easily and reduce the fault rate, the light tree further comprises a shell 41, shown as FIG. 7, the shell wraps the electric socket I 4 and the electric plug II 5 inside and is provided with the corresponding circuit holes.

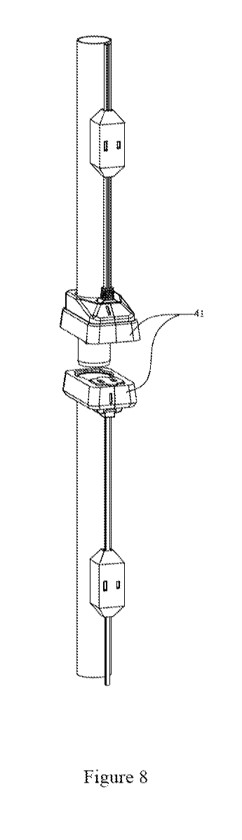

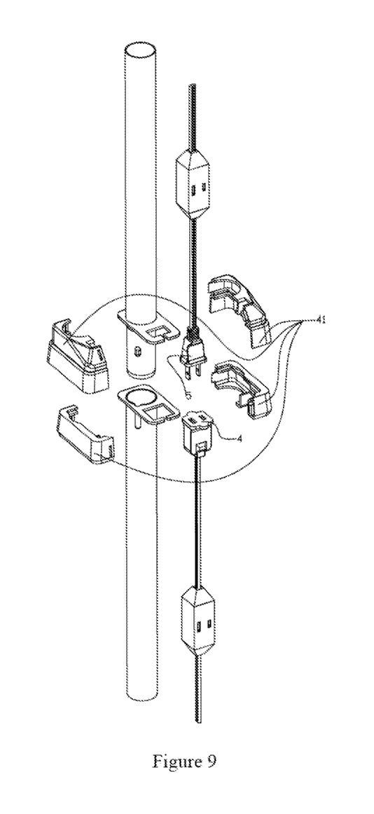

In order to being mounted conveniently, the shell is composed of a left half shell and a right half shell which are detachably and fixedly connected or an upper half shell and a lower half shell which are connected in the same way. As FIG. 8, the shell is composed of an upper part and a lower part. The detachable and fixed connection hereby refers to fastening, nesting or nut-bolt connection.

In order to further facilitate mounting, the left half shell as well as the right half shell consists of an upper part and a lower part. As FIG. 9, the shell is formed by four parts.

1. A modularized artificial light tree at least comprises a first simulative bole and a second simulative bole, characterized in that:
Both the first simulative bole and the second simulative bole are hollow tube stocks, and the top of the first simulative bole is detachably and fixedly connected with the bottom of the second simulative bole;
The top of the outer wall of the first simulative bole is fixedly connected with the electric socket I, and the bottom of the outer wall of the second simulative bole is provided with an electric plug II matched with the electric socket I and is fixedly connected with the electric plug II.
The light tree further comprises at least one string light. The tail end of each string light is provided with an electric plug III, the first simulative bole also comprises another electric socket II matched with the electric plug III, and the said electric socket II is fixed on the outer wall of the first simulative bole.
The electric socket I and the electric plug II are supplied with the power together.

2. A light tree as claimed in claim 1, also characterized in that the light tree further comprises several holders, each holder comprises a holding hole and a positioning hole, the holding holes are matched with electric connectors, and the positioning holes are matched with the simulative boles.

3. A light tree as claimed in claim 2, characterized in that the top of the first simulative bole is provided with a groove or projection, and the bottom of the second simulative bole is provided with a projection I or a groove I matched with the said groove or projection.

4. A light tree as claimed in claim 3, characterized in that at least one electric socket I and at least one electric plug II are provided.

5. A light tree as claimed in claim 4, characterized in that when provided more than two, the electric plugs II are staggered.

6. A light tree as claimed in claim 5, characterized in that the cross section of the electric socket I and that of the first simulative bole are parallel to each other or arranged on the same plane.

7. A light tree as claimed in claim 1, characterized in that the light tree further comprises a third simulative bole, the top of the third simulative bole comprises an electric socket IV connected with another simulative bole and at least one electric plug IV I connected with the string lights. The top of the second simulative bole further comprises an electric socket II I, and the bottom of the third simulative bole comprises an electric plug IV II matched with the electric socket II I.

8. A light tree as claimed in claim 1, characterized in that the light tree further comprises a shell. The shell wraps the electric socket I and the electric plug II inside and is provided with corresponding circuit holes.

9. A light tree as claimed in claim 8, characterized in that the shell is composed of a left half shell and a right half shell which are detachably and fixedly connected or of an upper half shell and a lower half shell which are connected in the same way.

10. A light tree as claimed in claim 9, characterized in that the left half shell as well as the right half shell consists of an upper part and a lower part.
